(19) United States
(12) Patent Application Publication
(10) Pub. No.: US 2015/0131103 A1
(43) Pub. Date: May 14, 2015

(54) NOISE COMPENSATED FIBER OPTIC SENSING SYSTEMS AND METHODS OF OPERATING THE SAME

(71) Applicant: US Seismic Systems, Inc., Chatsworth, CA (US)

(72) Inventors: Eric L. Goldner, Valencia, CA (US); Gerald Robert Baker, West Hills, CA (US)

(73) Assignee: US Seismic Systems, Inc., Chatsworth, CA (US)

(21) Appl. No.: 14/115,921

(22) PCT Filed: Aug. 14, 2013
(86) PCT No.: PCT/US13/54880

§ 371 Date: Nov. 6, 2013

Related U.S. Application Data
(60) Provisional application No. 61/682,795, filed on Aug. 14, 2012.

(51) Int. Cl. G01D 5/353; G01D 18/00

(52) U.S. Cl. CPC G01D 5/35303; G01D 18/00
USPC 356/478

(57) ABSTRACT

A fiber optic sensing system. The fiber optic sensing includes an optical source and a lead cable for receiving an optical signal from the optical source. The fiber optic sensing system also includes a sensor array for receiving the optical signal from the lead cable. The sensor array includes a plurality of fiber optic sensors, each of the plurality of fiber optic sensors including an interferometer having two legs. The plurality of fiber optic sensors includes a noise compensation sensor. Each of the legs of the interferometer of the noise compensation sensor is configured to sense vibration in substantially the same manner.

### RELATED APPLICATION

This application claims the benefit of priority to U.S. Provisional Patent Application Ser. No. 61/682,795, filed on Aug. 14, 2012, the contents of which are incorporated in this application by reference.

### TECHNICAL FIELD

The field of the invention relates to apparatuses and methods that compensate for noise within a fiber optic sensing system and, more particularly, to using a noise compensation sensor in connection with such apparatuses and methods.

### BACKGROUND OF THE INVENTION

Fiber optic sensing systems are utilized in various applications such as, for example, seismic sensing. Interferometer-based sensors are often used in such fiber optic sensing systems to sense information about a physical quantity being measured (e.g., temperature, pressure, etc.). Such fiber optic sensing systems are subject to various sources of noise that are indistinguishable from the primary measurable quantity of interest. As used in this document, the term “noise” may refer to any information unrelated to the physical quantity being measured.

Exemplary noises include phase noise generated in a lead cable; phase noise generated in an optical source; relative intensity noise (RIN) generated in an optical source; intensity noise generated in a lead cable; and power supply noise. Such noises introduce complexities in the analysis of signals returned from the sensing portion of fiber optic sensing systems. Thus, there remains a need in the industry to address such noises.

### BRIEF SUMMARY OF THE INVENTION

To meet this and other needs, and according to exemplary embodiments of the present invention, a fiber optic sensing system is provided. The fiber optic sensing system includes an optical source and a lead cable for receiving an optical signal from the optical source. The fiber optic sensing system also includes a sensor array for receiving the optical signal from the lead cable. The sensor array includes a plurality of fiber optic sensors, each of the plurality of fiber optic sensors including an interferometer having two legs. The plurality of fiber optic sensors includes a noise compensation sensor. Each of the legs of the interferometer of the noise compensation sensor is configured to sense vibration in substantially the same manner. Also disclosed are methods of operating the system.

According to another exemplary embodiment of the present invention, another fiber optic sensing system is provided. The fiber optic sensing system includes an optical source and a lead cable for receiving an optical signal from the optical source. The fiber optic sensing system also includes a sensor array for receiving the optical signal from the lead cable. The sensor array includes a plurality of fiber optic sensors, each of the plurality of fiber optic sensors including an interferometer having two legs. The plurality of fiber optic sensors includes a noise compensation sensor. Each of the legs of the interferometer of the noise compensation sensor is substantially insensitive to physical perturbations.

According to yet another exemplary embodiment of the present invention, a method of compensating for noise in a fiber optic sensing system is provided. The method includes the steps of: (a) receiving a composite signal from a fiber optic sensing system, the composite signal including information about at least one physical quantity being measured and information unrelated to the at least one physical quantity being measured; and (b) removing at least a portion of the information unrelated to the at least one physical quantity being measured.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a block diagram of a fiber optic sensing system in accordance with an exemplary embodiment of the present invention;

FIG. 2 a block diagram of another fiber optic sensing system in accordance with another exemplary embodiment of the present invention;

FIG. 3 a block diagram of another fiber optic sensing system in accordance with yet another exemplary embodiment of the present invention;

FIG. 4 is a graphical illustration of a composite signal, a noise signal portion of the composite signal, and a compensated signal with the noise signal portion removed, in accordance with an exemplary embodiment of the present invention; and

FIG. 5 is a flow diagram illustrating a method of compensating for noise in a fiber optic sensing system in accordance with an exemplary embodiment of the present invention.

### DETAILED DESCRIPTION OF THE INVENTION

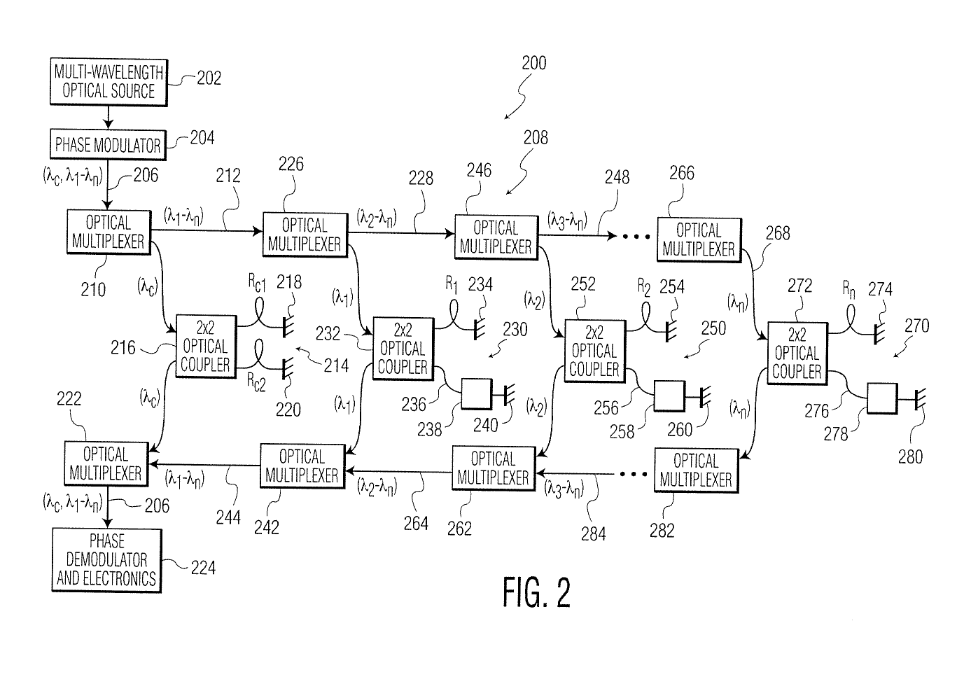

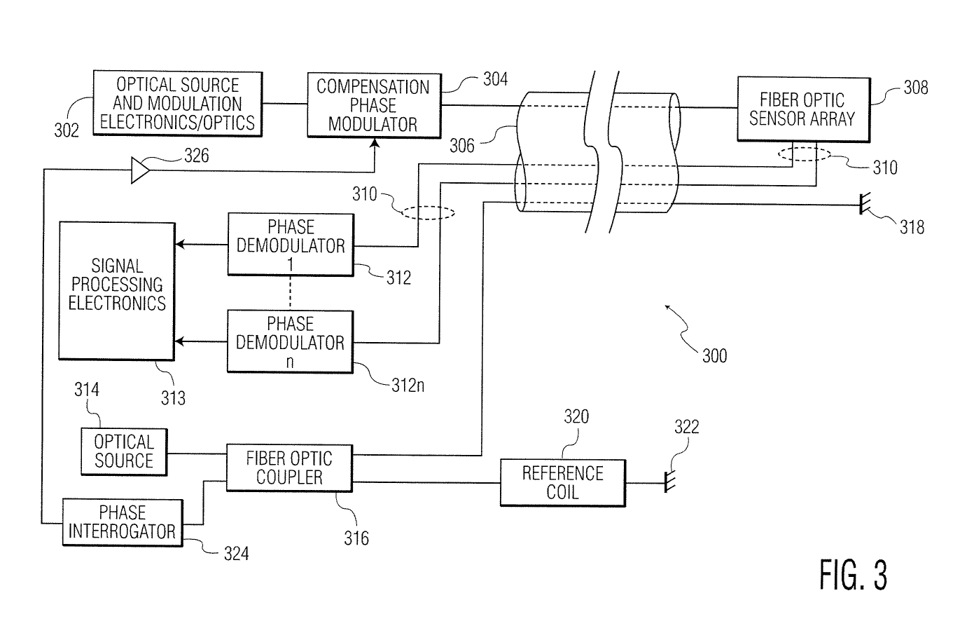

As will be explained in greater detail below, according to certain exemplary embodiments of the present invention, improved systems and methods for compensating for noise (e.g., lead cable noise, optical source noise, etc.) in fiber optic sensing systems are provided. In certain exemplary fiber optic sensing systems (including interferometer-based sensing systems), an additional “dead” fiber optic sensor (e.g., an interferometer-based sensor where the additional sensor/interferometer is only sensitive to noise, and not to the primary measurable quantity of interest) is included in the fiber optic sensor system. The purpose of this dead sensor is to detect only noise common to the other “active” sensors. In one exemplary embodiment of the present invention, hardware or software compensation of the output data from the active sensors is accomplished by use of the demodulated output from the dead sensor (e.g., see FIG. 2). In another exemplary embodiment of the present invention, adaptive noise reduction is utilized that actively cancels noise using a compensation phase modulator that applies a compensating phase into the lead cable that is equal in magnitude and opposite in sign to the instantaneous noise affecting the system (e.g., see FIG. 3).

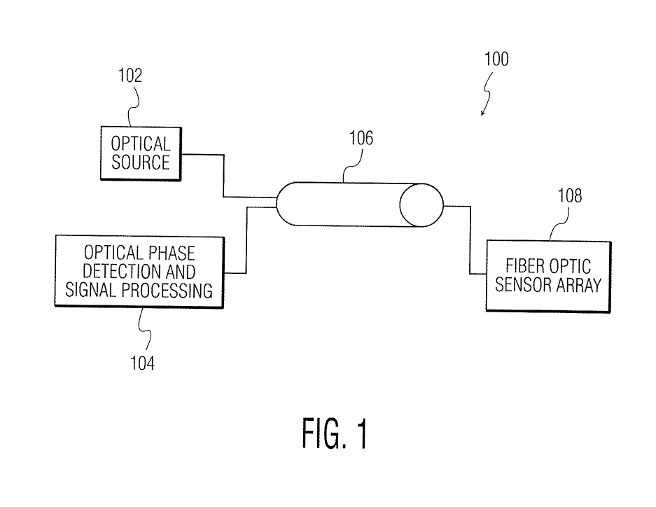

FIG. 1 illustrates basic elements of a fiber optic sensing system 100. Fiber optic sensing system 100 includes an optical source 102 (e.g., a multi-wavelength, highly coherent optical source) for transmitting an optical signal (e.g., a multi-wavelength optical signal) along a fiber optic lead cable 106 to a fiber optic sensor array 108. Noise exists in fiber optic sensing system 100, for example, from optical source 102 and lead cable 106. Fiber optic sensor array 108 includes a plurality of fiber optic sensors (e.g., interferometric sensors including a sensing leg and a reference leg) for sensing one or more physical quantities. For example, optical multiplexers may be used to strip individual wavelengths from the optical signal for each of the plurality of fiber optic sensors. Fiber optic sensor array 108 also includes a noise compensation sensor (e.g., an interferometric sensor where the legs are potted or are otherwise insensitive to the mechanical perturbations or whatever physical stimulus is being sensed by the active fiber optic sensors in fiber optic sensor array 108). In certain exemplary embodiments of the present invention where each of the sensors of sensor array 108 includes an interferometer, each of the legs of the interferometer of the noise compensation sensor is configured to sense vibration in substantially the same manner (in contrast to the interferometers of the active sensors including a sensing leg and a reference leg).

The optical signals returned from fiber optic sensor array 108 are received by an optical phase detection and signal processing element 104 for analysis of the optical signals. The optical signals at each wavelength (e.g., the optical signals from each of the optical sensors in fiber optic sensor array 108) include the common noise (e.g., the noise from optical source 102 and/or from lead cable 106). These optical signals also include information related to the physical stimuli being measured by the respective sensor. The portion of the return optical signal from the noise compensation sensor does not include any (or substantially any) information related to any physical stimuli, however, because the sensor is insensitive to such stimuli. Thus, the information returned from the noise compensation sensor is primarily (if not completely) noise. By removing (e.g., subtracting through hardware, subtracting through software, etc.) the noise sensed by the noise compensation sensor from the optical signal from each of the active fiber optic sensors (at each of the wavelengths), the remaining signal more closely approximates the desired signal (i.e., a signal including information related to the physical stimuli being measured by the respective sensor).

Many different implementations of the system described above with respect to FIG. 1 are contemplated within the scope of the present invention. The noise compensation/removal may be accomplished via hardware (e.g., using amplifiers such as inverting amplifiers, summing amplifiers, etc.), software (e.g., using digital code), etc. FIGS. 2 and 3 illustrate two non-limiting examples.

FIG. 2 illustrates a fiber optic sensing system 200 (e.g., a Wavelength Division Multiplexed or WDM-based system) including a multi-wavelength optical source 202 transmitting light (e.g., an optical signal of different wavelengths) to a phase modulator 204. The multi-wavelength modulated light (including wavelengths λ_{c} and λ₁-λₙ), with a phase carrier, is transmitted over a fiber optic lead cable 206 to a fiber optic sensor array 208. Noise exists in lead cable 206, for example, by movement of lead cable 206, through temperature changes along lead cable 206, etc., which causes additional phase changes to be imparted to the optical signal (which cannot be demodulated) and is thereby phase noise.

Fiber optic sensor array 208 includes a plurality of fiber optic sensors including sensor 214 (i.e., the noise compensation sensor receiving light at λ_{c}), a sensor 230 receiving light at λ₁, a sensor 250 receiving light at λ₂, and a sensor 270 receiving light at λₙ(e.g., with additional sensors between sensor 250 and sensor 270 configured to receive light at λ₃, λ₄, etc.). More specifically, in the wavelength division multiplexing embodiment shown in FIG. 2, each of a plurality of wavelengths of light are sequentially stripped off the multi-wavelength light via a series of filters/optical multiplexers (such as optical add/drop multiplexers), where only one wavelength λ is directed to each sensor 214, 230, 250, 270. Sensors 230, 250, 270 are active sensors, sensitive to a particular disturbance (e.g., temperature, vibration, etc.). Sensor 214 is a noise compensation sensor that is insensitive to disturbances, but is of substantially the same optical configuration (e.g., path length difference between the two arms of the interferometer) as the active sensors.

Referring again to FIG. 2, the multi-wavelength optical signal is received by an optical multiplexer 210 which strips off wavelength λ_{c} for transmission to noise compensation sensor 214, allowing the remaining wavelengths of light (λ₁-λₙ) to pass along a fiber 212 to the remaining (active) fiber optic sensors 230, 250, 270. Noise compensation sensor 214 is an interferometric sensor that includes a 2×2 optical coupler 216 which divides the light between two legs. That is, a first portion of the light is transmitted from optical coupler 216 to a first leg including a reference coil R_{c1} and a reflector 218, where the first portion is reflected back from reflector 218 to optical coupler 216. Likewise, a second portion of the light is transmitted from optical coupler 216 to a second leg including a reference coil R_{c2} and a reflector 220, where the second portion is reflected back from reflector 220 to optical coupler 216. The two light portions recombine at optical coupler 216 coherently and the resulting time-varying intensity signal is transmitted to an optical multiplexer 222.

The optical signal including the remaining wavelengths of light (λ₁-λₙ) is received by an optical multiplexer 226 which strips off wavelength λ₁ for transmission to active fiber optic sensor 230, allowing the remaining wavelengths of light (λ₂-λ₁) to pass along a fiber 228 to the remaining (active) fiber optic sensors. Sensor 230 is an interferometric sensor that includes a 2×2 optical coupler 232 which divides the light between two legs. A first portion of the light is transmitted from optical coupler 232 to a first leg including a reference coil R₁ and a reflector 234, where the first portion is reflected back from reflector 234 to optical coupler 232. A second portion of the light is transmitted from optical coupler 232 through a fiber 236 to a second leg including a transducer 238 (such as a fiber optic hydrophone) and a reflector 240, where the second portion is reflected back from reflector 240 to optical coupler 232. The two light portions recombine coherently at optical coupler 232 and the resulting time-varying intensity signal is transmitted to an optical multiplexer 242.

The optical signal including the remaining wavelengths of light (λ₂-λₙ) is received by an optical multiplexer 246 which strips off wavelength λ₂ for transmission to active fiber optic sensor 250, allowing the remaining wavelengths of light (λ₃-λₙ) to pass along a fiber 248 to the remaining (active) fiber optic sensors. Sensor 250 is an interferometric sensor that includes a

2×2 optical coupler 252 which divides the light between two legs. A first portion of the light is transmitted from optical coupler 252 to a first leg including a reference coil R₂ and a reflector 254, where the first portion is reflected back from reflector 254 to optical coupler 252. A second portion of the light is transmitted from optical coupler 252 through a fiber 256 to a second leg including a transducer 258 (such as a fiber optic hydrophone) and a reflector 260, where the second portion is reflected back from reflector 260 to optical coupler 252. The two light portions recombine coherently at optical coupler 252 and the resulting time-varying intensity signal is transmitted to an optical multiplexer 262.

The optical signal including the remaining wavelengths of light (λ₃-λₙ) is transmitted to additional fiber optic sensors (not shown) until the final wavelength of light (λₙ) is received by an optical multiplexer 266 which passes wavelength λₙ for transmission through a fiber 268 to active fiber optic sensor 270. Sensor 270 is an interferometric sensor that includes a 2×2 optical coupler 272 which divides the light between two legs. A first portion of the light is transmitted from optical coupler 272 to a first leg including a reference coil Rₙ and a reflector 274, where the first portion is reflected back from reflector 274 to optical coupler 272. A second portion of the light is transmitted from optical coupler 272 through a fiber 276 to a second leg including a transducer 278 (such as a fiber optic hydrophone) and a reflector 280, where the second portion is reflected back from reflector 280 to optical coupler 272. The two light portions recombine coherently at optical coupler 272 and the resulting time-varying intensity signal is transmitted to an optical multiplexer 282.

The recombined signals at each of optical multiplexers 282, 262, 242, 222 are sequentially combined (through a series of fibers 284, 264, 244) into a multi-wavelength signal. For example, the recombined signal from optical coupler 216 is combined with the other recombined signals (from optical multiplexer 242) at optical multiplexer 222. The multi-wavelength signal is transmitted from optical multiplexer 222 to a phase demodulator and electronics element 224.

The multi-wavelength signal received by element 224 includes content from each of sensors 214, 230, 250, and 270. Each of active sensors 230, 250, and 270 returns information containing both sensed (desired) signals and noise (such as lead cable noise). Because noise compensation sensor 214 is constructed in such a way as to render it insensitive to disturbances, its return contains only noise (e.g., the same lead cable noise as that injected into the active sensors). In the phase demodulator and electronics element 224, the demodulated phase of each active sensor 230, 250, 270 is acted upon with the demodulated signal from the compensation sensor 214 (e.g., by subtraction of the noise content of sensor 214 from the content of active sensors 230, 250, and 270).

FIG. 3 illustrates a fiber optic sensing system 300 including a multi-wavelength optical source (combined with modulation electronics/optics) in element 302. A multi-wavelength optical signal from element 302 is transmitted to a compensation phase modulator 304 (the function of which will be described below). The output signal from compensation phase modulator 304 (e.g., a multi-wavelength modulated optical signal provided with a phase carrier) is transmitted over a fiber lead cable 306. Movement in cable 306 as well as temperature changes and other causes tend to result in additional phase changes imparted to the optical signal (which cannot be demodulated), and are thereby phase noise. At a distal end of lead cable 306 is a fiber optic sensor array 308 including a plurality of fiber optic sensors (e.g., interferometer-based sensors). Signals from the fiber optic sensors of fiber optic sensor array 308 are returned along a plurality of return optical fibers 310 within lead cable 306. Signals transmitted along optical fibers 310 are received by respective phase demodulators 1-n (e.g., a phase demodulator 312 through a phase demodulator 312n) for demodulation and transmission (e.g., as analog or digital signals) to a signal processing electronics element 313 for subsequent processing and data analysis.

Another optical source 314 provides an optical signal which may or may not be modulated. The optical signal is received by a fiber optic coupler 316 (where coupler 316 is part of a noise compensation interferometer such as a Michelsen interferometer). Fiber optic coupler 316 may desirably be located near optical source 314, optical source and modulation electronics/optics element 302, and compensation phase modulator 304. The optical signal is divided by fiber optic coupler 316, where a first portion of the signal is transmitted along a first leg of the noise compensation interferometer (being a fiber within lead cable 306) and terminating at a reflector 318 (which may be generally located near fiber optic sensor array 308). The second portion of the signal is transmitted along a second leg of the noise compensation interferometer which is a reference coil 320 of an optical fiber (e.g., which is insensitive to physical perturbations, such as vibration, rapid temperature changes, etc.) and terminating at a reflector 322. The path length difference between the two legs of the noise compensation interferometer is substantially the same as that of the active sensors in fiber optic sensor array 308.

The reflected optical signal portions from each of reflectors 318, 322 are recombined coherently at fiber optic coupler 316, where the output of coupler 316 may be a time-varying intensity signal that is proportional to the instantaneous optical phase change (and hence the perturbation) within the fiber in lead cable 306. Fiber optic coupler 316 provides the signal to a phase interrogator 324 (e.g., which may be a demodulator), and the resulting electrical signal from interrogator 324 is an electrical signal (e.g., an analog voltage signal) proportional to the phase noise induced to lead cable 306 as a function of time. The output of phase interrogator 324 is passed into an inverting amplifier 326 and provides an electrical drive to compensation phase modulator 304 provided in the output optical path of optical source and modulation electronics/optics element 302 that is used to provide the optical signal for the active sensors in fiber optic sensor array 308 (where the output of phase interrogator 324, and the further output of inverting amplifier 326, is part of an electronic feedback path controlling compensation phase modulator 304). The phase output of compensation phase modulator 304 is substantially the same magnitude but 180 degrees out-of-phase with respect to the phase noise generated in lead cable 306, thus providing a continually changing, nulling effect on the phase noise in lead cable 306.

As will be appreciated by those skilled in the art, the various elements of system 300 to the left of lead cable 306 (including for example elements 302, 304, 312-312n, 314, 316, 320, 322, 324, and 326) may be in the “dry” end (e.g., a protected electronics enclosure). In contrast, the various elements to the right of lead cable 306 (including for example elements 308 and 318) may be in the “wet” end (i.e., the environment of the area to be sensed), such as in a borehole, in water, etc., depending upon the specific type of sensing system and its application.

Although the exemplary embodiment of FIG. 3 illustrates one leg of the noise compensation interferometer being in the dry end of system 300 (i.e., the leg including elements 320 and 322), it will be appreciated that both legs of the interferometer may be located at the distal end of the lead cable 306.

Although not illustrated in the configuration of FIG. 3, it may be desirable that the optical fiber included in lead cable 306 for the noise compensation sensor (i.e., the optical fiber between elements 316 and 318) be the same optical fiber on which the input optical signal for the active fiber optic sensors is transmitted (i.e., the optical fiber between elements 304 and 308). Thus, although not specifically illustrated, such an arrangement is contemplated within the scope of the present invention.

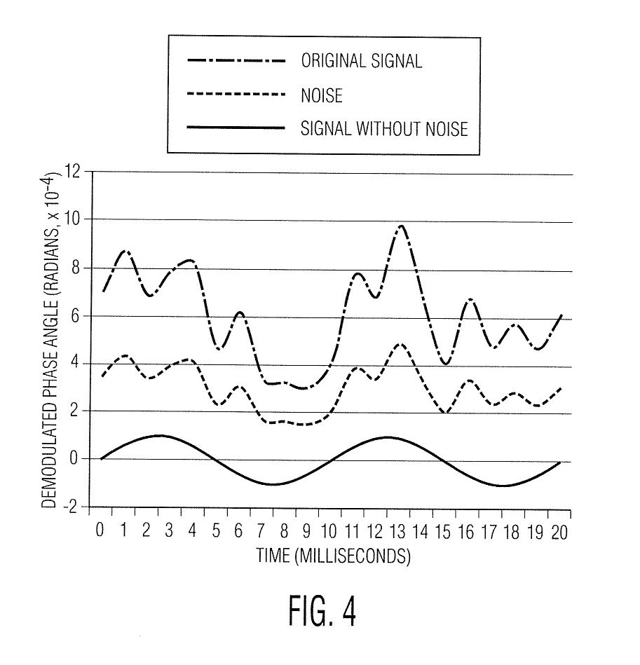

FIG. 4 is a graphical illustration of time-based traces useful in explaining exemplary embodiments of the present invention, such as those shown in FIGS. 1-3. The upper trace illustrates an exemplary output composite signal from an active sensor of a sensor array, where the trace includes the effects of unwanted lead cable noise. The center trace illustrates an output of a noise compensation sensor (e.g., an environmentally dead sensor) which is composed entirely of unwanted noise. After removing the center trace from the upper trace (using any exemplary technique in accordance with the present invention) the lower trace is achieved. The lower trace illustrates only the signal of interest (the sensor's response to a physical stimulus) without the unwanted noise.

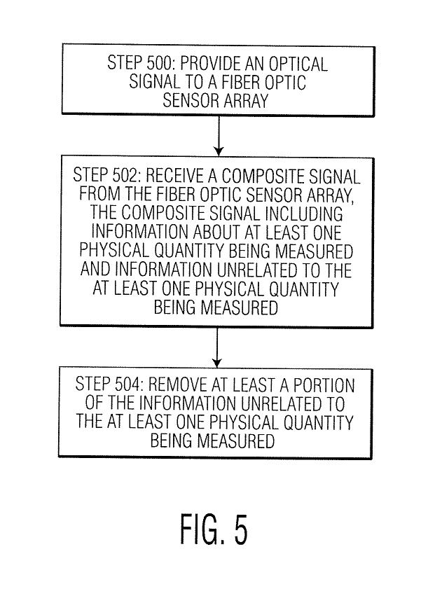

The inventive structures and techniques disclosed in this document may also take the form of methods for operating fiber optic sensor systems and, more specifically, of methods that compensate for noise in fiber optic sensing systems. FIG. 5 is a flow diagram illustrating a method of compensating for noise in a fiber optic sensing system. At step 500, an optical signal (e.g., a multi-wavelength optical signal) is provided to a fiber optic sensor array. At step 502, a composite signal is received from the fiber optic sensor array. The composite signal includes information about at least one physical quantity being measured (e.g., temperature information, pressure information, etc.) and information unrelated to the at least one physical quantity being measured (i.e., noise). At step 504, at least a portion of the information unrelated to the at least one physical quantity being measured is removed from the composite signal (e.g., see FIG. 4). As will be appreciated by those skilled in the art, additional steps may be added (including details of the steps recited above), and steps may be deleted, within the scope of the present invention. Further, any of the teachings of the present invention recited above, including the descriptions of FIGS. 1-4, may have applicability in the method described above with respect to FIG. 5 depending upon the desired application.

As will be appreciated by those skilled in the art, the sensors described in this document (including transducers 238, 258, 278 shown in FIG. 2, and sensors in fiber optic sensor array 308 shown in FIG. 3) may be any type of fiber optic sensor desired in the given configuration including, for example, dynamic pressure sensors (hydrophones) and optical fiber accelerometers, among others. In one specific embodiment, the active sensors (not the noise compensation sensor) are accelerometers. The accelerometers may include a transducer as part of a sensing leg, where the transducer includes (a) a fixed portion configured to be secured to a body of interest, (b) a moveable portion having a range of motion with respect to the fixed portion, (c) a spring positioned between the fixed portion and the moveable portion, and (d) a length of fiber wound between the fixed portion and the moveable portion, the length of fiber spanning the spring. Further, each of the fixed portion, the moveable portion, and the spring may be formed from a unitary piece of material. Examples of such transducers and accelerometers are disclosed in PCT International Publication Number WO/2011/050227 entitled “Fiber Optic Transducers, Fiber Optic Accelerometers, And Fiber Optic Sensing Systems.”

The fiber optic sensing systems and methods disclosed in this document have wide applicability and may be used in many different applications where fiber optic sensing may be utilized, for example, fiber optic microseismic detection systems, fiber optic vertical seismic profiling systems, fiber optic tunnel detection systems, fiber optic perimeter security systems, fiber optic seismic streamer systems, and fiber optic towed hydrophone arrays, among others.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A fiber optic sensing system comprising:
an optical source providing an optical signal;
a lead cable for receiving the optical signal from the optical source; and
a sensor array for receiving the optical signal from the lead cable, the sensor array including a plurality of fiber optic sensors, each of the plurality of fiber optic sensors including an interferometer having two legs, the plurality of fiber optic sensors including a noise compensation sensor, wherein each of the legs of the interferometer of the noise compensation sensor is configured to sense vibration in substantially the same manner.

2. The fiber optic sensing system of claim 1 wherein each of the legs of the interferometer of the noise compensation sensor is substantially insensitive to physical perturbations.

3. The fiber optic sensing system of claim 1 wherein ones of the plurality of fiber optic sensors are configured to output an intensity signal related to physical stimuli acting on the corresponding one of the plurality of fiber optic sensors.

4. The fiber optic sensing system of claim 1 further comprising an interrogator for converting the intensity signal from each of the plurality of fiber optic sensors into a corresponding electrical signal.

5. The fiber optic sensing system of claim 1 wherein the noise compensation sensor is configured to receive light from the optical signal at a wavelength that is different from light from the optical signal received by others of the plurality of fiber optic sensors.

6. The fiber optic sensing system of claim 1 further comprising a phase modulator for modulating the optical signal from the optical source before the optical signal is received by the lead cable.

7. The fiber optic sensing system of claim 6 further comprising an electronic feedback path controlling the phase modulator and using as its input a demodulated output of the noise compensation sensor.

8. The fiber optic sensing system of claim 7 wherein the electronic feedback path is configured to apply a signal to the phase modulator that is inverted in sign relative to the demodulated output to compensate for noise sensed by the noise compensation sensor.

9. The fiber optic sensing system of claim 1 wherein ones of the plurality of fiber optic sensors are accelerometers, excluding the noise compensation sensor, include a transducer as part of a sensing leg, the transducer including (a) a fixed portion configured to be secured to a body of interest, (b) a moveable portion having a range of motion with respect to the fixed portion, (c) a spring positioned between the fixed portion and the moveable portion, and (d) a length of fiber wound between the fixed portion and the moveable portion, the length of fiber spanning the spring.

10. The fiber optic sensing system of claim 9 wherein each of the fixed portion, the moveable portion, and the spring is formed from a unitary piece of material.

11. A fiber optic sensing system comprising:
an optical source providing an optical signal;
a lead cable for receiving the optical signal from the optical source; and
a sensor array for receiving the optical signal from the lead cable, the sensor array including a plurality of fiber optic sensors, each of the plurality of fiber optic sensors including an interferometer having two legs, the plurality of fiber optic sensors including a noise compensation sensor, wherein each of the legs of the interferometer of the noise compensation sensor is substantially insensitive to physical perturbations.

12. The fiber optic sensing system of claim 11 wherein each of the legs of the interferometer of the noise compensation sensor is configured to sense vibration in substantially the same manner.

13. The fiber optic sensing system of claim 11 wherein ones of the plurality of fiber optic sensors are configured to output an intensity signal related to physical stimuli acting on the corresponding one of the plurality of fiber optic sensors.

14. The fiber optic sensing system of claim 11 further comprising an interrogator for converting the intensity signal from each of the plurality of fiber optic sensors into a corresponding electrical signal.

15. The fiber optic sensing system of claim 11 wherein the noise compensation sensor is configured to receive light from the optical signal at a wavelength that is different from light from the optical signal received by others of the plurality of fiber optic sensors.

16. The fiber optic sensing system of claim 11 further comprising a phase modulator for modulating the optical signal from the optical source before the optical signal is received by the lead cable.

17. The fiber optic sensing system of claim 16 further comprising an electronic feedback path controlling the phase modulator and using as its input a demodulated output of the noise compensation sensor.

18. The fiber optic sensing system of claim 17 wherein the electronic feedback path is configured to apply a signal to the phase modulator that is inverted in sign relative to the demodulated output to compensate for noise sensed by the noise compensation sensor.

19. The fiber optic sensing system of claim 11 wherein ones of the plurality of fiber optic sensors are accelerometers, excluding the noise compensation sensor, include a transducer as part of a sensing leg, the transducer including (a) a fixed portion configured to be secured to a body of interest, (b) a moveable portion having a range of motion with respect to the fixed portion, (c) a spring positioned between the fixed portion and the moveable portion, and (d) a length of fiber wound between the fixed portion and the moveable portion, the length of fiber spanning the spring.

20. The fiber optic sensing system of claim 19 wherein each of the fixed portion, the moveable portion, and the spring is formed from a unitary piece of material.

21. A method of compensating for noise in a fiber optic sensing system, the method comprising the steps of:
(a) receiving a composite signal from a fiber optic sensing system, the composite signal including information about at least one physical quantity being measured and information unrelated to the at least one physical quantity being measured; and
(b) removing at least a portion of the information unrelated to the at least one physical quantity being measured.

22. The method of claim 21 wherein the fiber optic sensing system includes a sensor array for receiving an optical signal from an optical source, the sensor array including a plurality of fiber optic sensors, each of the plurality of fiber optic sensors including an interferometer having two legs, the plurality of fiber optic sensors including a noise compensation sensor, wherein each of the legs of the interferometer of the noise compensation sensor is substantially insensitive to physical perturbations.

23. The method of claim 21 wherein the fiber optic sensing system includes a sensor array for receiving an optical signal from an optical source, the sensor array including a plurality of fiber optic sensors, each of the plurality of fiber optic sensors including an interferometer having two legs, the plurality of fiber optic sensors including a noise compensation sensor, wherein each of the legs of the interferometer of the noise compensation sensor is configured to sense vibration in substantially the same manner.

24. The method of claim 21 wherein step (a) includes receiving the composite signal for each of a plurality of fiber optic sensors of the fiber optic sensing system, and step (b) includes removing at least a portion of the information unrelated to the at least one physical quantity being measured from the composite signal for each of the plurality of fiber optic sensors.

25. The method of claim 24 further comprising the step of receiving a compensation signal from a noise compensation sensor included in the fiber optic sensing system, and wherein step (b) includes removing at least the portion of the information unrelated to the at least one physical quantity being measured by removing the received compensation signal from the composite signal for each of the plurality of fiber optic sensors.

26. The method of claim 25 wherein the noise compensation sensor includes an interferometer having two legs, wherein each of the legs of the interferometer of the noise compensation sensor is configured to sense vibration in substantially the same manner.

27. The method of claim 25 wherein the noise compensation sensor includes an interferometer having two legs, each of the legs of the interferometer of the noise compensation sensor is substantially insensitive to physical perturbations.

28. The method of claim 21 wherein step (b) includes removing at least the portion of the information unrelated to the at least one physical quantity being measured using software.

29. The method of claim 21 wherein step (b) includes removing at least the portion of the information unrelated to the at least one physical quantity being measured using hardware.

30. The method of claim 21 wherein a multi-wavelength phase modulated optical signal is transmitted to a sensor array of the fiber optic sensing using an optical source and a phase modulator, and wherein step (b) includes removing at least the portion of the information unrelated to the at least one physical quantity being measured by controlling the phase modulator using an electronic feedback path.

31. The method of claim 30 wherein the electronic feedback path uses a demodulated output of a noise compensation sensor as its input.

32. The method of claim 31 wherein the feedback path is configured to apply a signal to the phase modulator that is inverted in sign relative to the demodulated output.
